(19) United States
(12) Patent Application Publication
(10) Pub. No.: US 2025/0065294 A1
(43) Pub. Date: Feb. 27, 2025

(54) A Reactor for Converting Gaseous Carbon-Containing Reactants to Solid Carbon Product and Associated Methods

(71) Applicant: CARBONOVA CORP., Calgary (CA)

(72) Inventors: Alireza ZARRABIAN, Calgary (CA); Pedro Rafael PEREIRA ALMAO, Calgary (CA); Hector Jose GUZMAN GOMEZ, Calgary (CA); Mina ZARABIAN, Calgary (CA)

(21) Appl. No.: 18/726,331

(22) PCT Filed: Apr. 13, 2023
(86) PCT No.: PCT/CA2023/050503

§ 371 Date: Jul. 2, 2024

Related U.S. Application Data
(60) Provisional application No. 63/330,413, filed on Apr. 13, 2022.

(51) Int. Cl. B01J 19/24; C01B 32/15; D01F 9/127

(52) U.S. Cl. CPC B01J 19/249; C01B 32/15; D01F 9/1278; B01J 2219/2451; B01J 2219/2461; B01J 2219/2475; B01J 2219/2479

(57) ABSTRACT

A reaction assembly has an elongate vessel defining a reaction chamber. Planar supports within the reaction chamber have surfaces for supporting a solid catalyst. The planar supports are mounted transversely to an elongate axis of the vessel, forming a series of spaced-apart barriers. A conduit introduces gas through openings between successive barriers such that gas flow through the conduit causes gas to flow along the support surfaces. With selection of an appropriate metal nanoparticle catalyst that may be seeded on the support surfaces. the reaction assembly may be used to produce carbon nanofibers from carbon monoxide and hydrogen, wherein the nanofibers may be subsequently removed via injection of a fluid.

### TECHNICAL FIELD

The invention relates generally to apparatus, methods and processes for using solid state catalysts to produce solid products, such as carbon nanofibers (CNF), from gaseous reactants. In particular, the present disclosure relates to a reactor design supporting the solid catalyst, and to a process for providing active catalyst sites for the reaction, growing carbon nanofibers on the active sites, harvesting the carbon nanofibers, preparing the substrate for the next replenishment, and reinjecting or reactivating catalyst on the substrate in the reactor.

### BACKGROUND

To increase energy efficiency and reduce greenhouse gases, there is a growing demand for lightweight materials containing carbon. Carbon materials additives have applications in over 40 sectors, including composites, batteries, plastics, coatings, etc. Carbon materials have a wide range of physical properties and are often known as multifunctional, meaning that they can have combinations of multiple useful physical properties such as mechanical strength, low density, low or high electrical conductivity, low or high thermal conductivity, electromagnetic, corrosion resistance, and UV resistance. Carbon can be found in different allotropes, such as amorphous carbon, graphite, graphene, diamonds, fullerenes, carbon nanofoams, carbon nanofibers, fibers, and nanotubes.

Production of carbon materials is, in general, divided into two categories of catalytic and non-catalytic methods.

Non-catalytic formation of carbon materials such as pyrolysis, exfoliation, and wet spinning require significant energy and results in high CO₂ footprint. For example, wet spinning of polyacrylonitrile (PAN) to produce carbon fibers requires between 1800-3000° C. heating. The Japanese Carbon Fiber Manufacturers Association in its LCA report indicated that carbon fibre production cause to release of 20 tons of carbon dioxide per ton of carbon fibre. Catalytic formation of carbon allows to reduce the energy, control the desired morphology, and produce higher purity of a specific morphology. However, the catalytic process suffers from low rate of production, and it is often performed in a batch- or semi-batch process.

Decomposition of carbon containing gases on the surface of metal and formation of carbon fibers (CF) has been known as a catastrophic corrosion mechanism in metallurgy since decades before CF finds advanced applications. Nucleation and growth of carbon on the inner side of the reactor's wall cause rupture of the metal surface and clogging the path, a phenomenon that is well studied as metal dusting and carburization. In general, the catalytic production of carbon is divided into two categories: fixed-bed and continuous.

Fixed-bed catalytic production of carbon occurs in two steps:
(1) the catalyst is placed on the support and enters the heating zone before the carbon containing gases flow; and
(2) the CF grows on the support, and the process is non-continuous.

For continuous catalytic production of carbon, the carbon containing gas and the catalyst are injected together into the heating zone. The catalyst may be introduced to the support as an already reduced form of iron or as a precursor of iron that is reduced before or during CF production. This process can be altered to produce different sizes of carbon fibers from micro to nano-size.

Carbon nanofiber (CNF) refers to fibers that in one direction (usually the diameter) are below 100 nm. While CNF growth has been regarded as a nuisance for decades in many catalytic processes such as steam cracking and reforming, it is of great interest and has gained increasing values for advanced applications.

In existing systems, carbon nanofiber production is often conducted as a batch or semi batch process, meaning that the reaction vessel must be cooled down and opened to physically remove the carbon containing cartridges. The catalyst must be replenished on the substrate surface to restart the process. These above challenges made production of carbon nanofibers expensive and inefficient.

For example, U.S. Pat. No. 9,096,435 discloses a system in which catalyst is loaded on a substrate or alternatively on a vessel located at the center of a heating zone where the carbon containing gas flow over the substrate. The reactant gas enters to the reactor through single path on one side of a vessel and exit from the other side of the vessel. The flow and the load of catalyst defines the space velocity and the resident time for carbon growth and determines the growth rate. The process is often performed in a semi-continuous process with a non-steady condition. As the product (carbon) is accumulated on the substrate, the partial pressure of the reactant varies throughout the reactor.

U.S. Pat. No. 7,077,999 discloses a monolith for imparting swirl to a gas stream includes a stack of alternating flat and corrugated strips defining channels for gas flow. The strips are attached, at an angle, to a carrier. Also, the corrugations of the corrugated strips may be skewed. The carrier defines a cylindrical shell for the strips, and the strips extend from the carrier to a central region. The strips are curved, typically having substantially the shape of involutes, and substantially fill the space between the central region and the shell. Due to the angle of attachment between the strips and the carrier, the gas flow channels are oriented in different directions, at different locations on the outlet face of the monolith. This structure therefore imparts swirl to gas flowing through the monolith.

US 2019/0262792 discloses a reaction apparatus for use in solid carbon production includes a reactor shell defining a reactor inlet and a reactor outlet. Concentric cylinders or substantially parallel plates of catalytic material are disposed within the reactor shell and are structured and adapted to expose at least one contact surface to gaseous reactants. Another apparatus includes a removable cartridge comprising a plurality of substantially parallel plates of catalytic material disposed within the reactor shell.

US 2022/0089442, published on Mar. 24, 2022 discloses a process and apparatus for producing carbon nanofibers. The process comprises two stages. The first stage involves oxidizing light hydrocarbon with carbon dioxide or water, or oxygen, or a combination thereof to a mixture of hydrogen and carbon monoxide. The second stage involves converting the produced hydrogen and the carbon monoxide to carbon nanofibers and steam. US 2022/0089442 is hereby incorporated by reference in its entirety.

### SUMMARY

In accordance with the invention, there is provided a reaction assembly comprising:
an inlet;
an outlet;
an elongate vessel defining a reaction chamber in fluid communication with the inlet and the outlet;
one or more planar supports within the reaction chamber, the one or more planar supports having surfaces for supporting a solid catalyst, and being mounted transversely to, and forming a series of spaced-apart barriers along, an elongate axis of the vessel; and
a conduit positioned within the reaction chamber and connected to the inlet or the outlet, the conduit comprising conduit openings positioned between successive barriers, such that gas flow from the inlet to the outlet causes gas to flow through the conduit and through the reaction chamber along the support surfaces between successive barriers.

The conduit may be coaxial with (e.g., and centrally along) the elongate vessel.

The vessel may have a uniform cross-section across the axial extent of the series of spaced-apart barriers.

The support surfaces may form a heat exchanger. The support surfaces may be thermally conductive.

The support surfaces may be connected to, and in thermal communication with, the conduit.

There may be a gap between each of the spaced-apart barriers and the elongate vessel, the gaps allowing gas flow along the length of the elongate vessel. E.g., at the gaps, there may be a clear line of sight along the edge of the vessel to allow the gas to pass unobstructed. The gap may be less than 20% of the diameter of the elongate vessel (e.g., measured normal to the elongate axis). The gap may be at least 5% of the diameter of the elongate vessel (e.g., measured normal to the elongate axis). The gap may extend around at least 270° of the circumference of each of the spaced-apart barriers. The gap may extend around the entire circumference of each of the spaced-apart barriers.

Each reaction sub-chamber may be open. An open sub-chamber may have no reaction assembly components positioned to obstruct gas flow between the conduit and the outer wall of the elongate vessel (e.g., in a direction parallel to the support surfaces around at least 270° about the conduit between at least 80% of the distance between the barriers). It will be appreciated that reaction assembly components include one or more conduit, walls of the elongate vessel, but may not include solid products produced by the reaction taking place within the reaction chamber.

Each reaction sub-chamber may be bounded by two barriers and a wall of the elongate vessel. The gap may or may not be within the reaction sub-chamber. In some embodiments, the gaps may allow gas to pass from between two barriers in one reaction sub-chamber to between to barriers in another reaction sub-chamber. This may help control the pressure within the vessel. In other embodiments a barrier (e.g., an elongate vessel with an inner wall and annular conduit) may prevent gas from passing from between two barriers in one reaction sub-chamber to between to barriers in another reaction sub-chamber.

The conduit may be connected to, or act as, a thermometer used to probe the temperature along the assembly.

The vessel may comprise a drainage exit for removing liquids.

The support surfaces may be spaced apart by at least 1 mm. The support surfaces may be spaced apart by at most 3 cm.

The pressure within the reaction chamber may be between 1-20 atm. the temperature within the reaction chamber may be between 450-580° C. The pressure within the reaction chamber may be between 2-20 atm.

The catalyst may be configured to catalyse a reaction which converts gaseous reactants into a solid product.

According to a further aspect, there is provided a method of producing carbon nanofibers using the reaction assembly described herein, the method comprising:

injecting gaseous reactants into the reaction chamber through multiple inlets and removing gas from the outlets such that a flow of the gaseous reactants passes over the solid catalyst, the solid catalyst being configured to convert the gaseous reactants into products, wherein the products include carbon nanofibers.

The reactants may comprise hydrogen and carbon monoxide. The reactants may also comprise some carbon dioxide, steam and/or light hydrocarbons (e.g., methane, ethane, propane and/or butane). The reactants may comprise a mixture obtained from the first reactor of the system described in US 2022/0089442. This reactor is configured to convert an oxidizing stream (for example CO₂, steam, oxygen or a combination thereof) and light hydrocarbons (e.g., C1 to C4) to produce an intermediate stream comprising CO and H₂ (e.g. in the volume proportion close to 1:1). The output mixture may also include unreacted portions of the reactants (CO₂, steam and/or unreacted light hydrocarbons).

A fluid containing catalytic particles may be injected into the assembly via the one or more inlets to populate the substrates with fresh nucleation to feed the growth of CNFs.

The catalytic particles may comprise one or more of: a group VIII metal, Fe, Ru, Os, Hs, Ni, Cu, Zn, Co and Mo.

The method may comprise annealing and reducing the catalytic particles to form a lower oxidation state of each active site.

The method may comprise, prior to a fluid carrying catalytic particles into the reaction chamber, forming a passive layer on the inner surface of outer vessel. Metal bodies and substrates may be passivated or covered with one or more inert materials, such as ceramic, to avoid participation in the desired chemical reaction (i.e., to avoid solid products being formed where on these surfaces rather than on the support surfaces as intended).

The method may comprise injecting one or more of the following gases into the reaction chamber: steam, inert gas, carbon dioxide, hydrocarbon and a reducing gas.

The method may comprise harvesting the carbon nanofibers by flowing a fluid through the reaction chamber to dislodge the carbon nanofibers from the support surfaces, and separating the carbon nanofibers from the fluid outside the reaction chamber.

The method may comprise, prior to harvesting the carbon nanofibers, introducing an oxidizing agent into the reaction chamber, and increasing the temperature inside the reaction chamber.

The method may comprise injecting fluids into the reaction chamber at different velocities to encourage mixing.

The method may comprise injecting catalyst particles into the reaction chamber in a seeding stage such that the catalyst particles are affixed to the support surfaces. In some embodiment, the catalyst particles may be activated by exposing them to particular environmental conditions (e.g., of pressure and/or temperature) and/or reactants (e.g., oxidising or reducing agents). In some embodiments the deposited catalyst particles do not require activation.

The method may comprise flowing fluid through the chamber in a harvesting stage to remove the grown carbon nanofibers from the catalyst support surfaces and to extract the removed carbon nanofibers from the reaction chamber. In other embodiments, harvesting may be achieved by other means, such as mechanical removal, for example, using a harvesting blade for cutting or shearing carbon nanofibers from the support surfaces.

According to a further aspect, there is provided a method of producing carbon nanofibers, the method comprising cycling between two or more of the following stages:
a seeding stage comprising catalyst particulates are injected into the reaction chamber, affixed to the support surfaces and then activated;
a growth stage in which gaseous reactants are flowed through the reaction chamber over the catalyst support surfaces to be converted into the carbon nanofibers; and
a harvesting stage in which a fluid is flowed through the reaction chamber to remove the grown carbon nanofibers from the catalyst support surfaces and to extract the removed carbon nanofibers from the reaction chamber.

This cycling of stages may be used in conjunction with any reaction vessel containing a support surface for growing carbon nanofibers.

In some embodiments, the fluids injected into the reaction vessel in each stage may be carried by dedicated conduits for each stage (e.g., a harvesting conduit, a reactant conduit and a seeding conduit). In other embodiments, the same conduit may be used in multiple stages (e.g., a common conduit being used for both seeding and harvesting stages).

According to a further aspect, there is provided a method of producing carbon nanofibers using the reaction assembly as described herein the method comprising cycling between the following stages:
a seeding stage in which catalyst particulates are injected into the reaction chamber, affixed to the support surfaces and then activated;
a growth stage in which gaseous reactants are flowed through the reaction chamber over the catalyst support surfaces to be converted into the carbon nanofibers; and
a harvesting stage in which a fluid is flowed through the reaction chamber to remove the grown carbon nanofibers from the catalyst support surfaces and to extract the removed carbon nanofibers from the reaction chamber.

The conditions within the reaction chamber may be conditions to facilitate the production of solid carbon. The reaction which produces solid carbon may occur at temperatures around 500° C. (e.g., from 300-800° C.). The reaction which produces solid carbon may occur at pressures around 10 atm (e.g., between 5-20 atm or between 6-10 atm).

In the context of this disclosure, a planar support may comprise a single sheet of material. The planar support may have support surfaces for solid catalyst on one or both sides. The planar support may be formed of a thermally conductive material (e.g., and have a metallic body). These features may improve heat transfer through the planar support (e.g., including along and transverse to the support surfaces). This may help ensure that the heat is distributed evenly within the reaction chamber.

In the context of this disclosure, a barrier may be considered a structure blocking a line of sight along the elongate vessel parallel to the elongate axis. A barrier may be transverse to (e.g., normal to) the elongate axis. A barrier may be formed from one planar support (e.g., a single circular support may be a single barrier). In some cases, a single support may form multiple barriers if it is curved so as to block a line of sight along the elongate vessel multiple times. For example, a single helical support which curves around the elongate axis may be considered to form multiple barriers. In such a case, each portion of the helical support which blocks 360° around the helical axis may be considered a single barrier, although not structurally distinct from the next barrier.

Planar supports in the context of this disclosure include supports which extend in two dimensions to form a plane but which have a limited thickness (e.g., with respect to the extended dimensions). A planar support may have a thickness of less than 5 mm (e.g., normal to the surface of the support). Planar supports may be flat (i.e., not curved or bent) or be curved or bent. The planar support maybe built from solid impermeable material or a permeable material such as foam or mesh. Planar supports may have rough support surfaces. Planar supports are typically rigid.

The planar supports may be directly connected to (e.g., mounted to) the conduit. This connection may prevent gases passing between the conduit and the planar supports (e.g., a sealed connection around the conduit). The planar support or barrier may extend around the conduit across a range of angles (e.g., 180° or more and up to a full 360°)

The conduit may extend into the body of the reaction chamber such that it is attached to a wall of the reaction chamber only at one or both ends (i.e., but not along the length of the conduit). That is, at least a length of the conduit within the reaction chamber may be spaced away from the walls of the elongate vessel. A conduit may be considered to be a channel for conveying a fluid. The conduit may be in the form of a tube or pipe.

The reactor may have an elongate vessel, possibly with a circular cross section, with one or plurality of inner perforated vessels or conduits with typically annular or circular cross section. A circular cross section vessel may allow heat to be distributed more evenly throughout the reaction chamber.

The elongate vessel may have a length at least 2 times as large as a transverse dimension (e.g., height and/or width).

The elongate vessel may be tiltable. The elongate vessel may be configured to operate in a tilted configuration with the elongate axis being at least 5° and/or at most 45° from the horizontal.

The barriers may be aligned with the vertical in operation (e.g., less than 30° or less than 5° to the vertical). In operation may be when the reactants are being converted to solid products, such as carbon nanofibers. The upright or vertical orientation of the barriers may reduce the force of liquids running across the surface of the solid catalyst and growing solid product. It may also ensure that the surfaces on which the solid products are growing are consistent (e.g., rather than have a significantly upward facing surface and a significantly downward facing surface).

The reaction assembly may have at least 10 barriers spaced apart along the length of the elongate vessel.

The perforated inner tube or conduit may be coaxial with the elongate vessel and parallel to the elongate vessel. Arranging the conduit centrally within the elongate vessel means that gas may pass in all directions from the central conduit. For a given catalyst support surface area, this minimizes the distance between where the reactant is injected and the edge of the catalyst support surface. For example, an embodiment where the inlet is placed towards the bottom of the catalyst support surface, reactant gas would have to travel a larger distance to reach the top. This embodiment may still be used to facilitate the reaction, but it may have a less uniform concentration of reactants at different points on the catalyst surface leading to less uniform growth. In other embodiments, the conduit may be positioned off center within the reaction chamber. In other embodiments, the conduit may be at an angle to the elongate axis within the reaction chamber. The conduit may be aligned with (e.g., parallel to) the elongate axis within the reaction chamber.

The perforated vessels or conduits may be used to inject a fluid of the reactants in a gas or liquid form or a combination thereof.

Perforations or openings in the inner tube or conduit may be adjusted to maintain the partial pressure of the reactants so that they are homogenous throughout the internal body of the reactor (e.g., pressures within 10%).

The size of openings, numbers, shapes, and distribution may be configured or adjusted to have a homogenous linear velocity of fluid throughout the outer vessel (below 0.5% to 10% difference) in planar (x-y), and perpendicular direction.

The perforations, holes or openings may be distributed in the conduit as a plurality of perforations distributed in 3 dimensions. Some may be in a same plane (x-y) with adjusted distance from 0.1 mm to 9999 mm between the holes (e.g., in the range of 0.1 mm to 50 mm). Some of the perforations are in a separate x-y plane with distance between planes from 0.1 to 9999 mm (e.g., in the range of 0.1 mm to 50 mm).

The planar supports may have a separation of between 0.1 mm and 9999 mm along the elongate axis (e.g., in the range of 0.1 mm to 50 mm).

The inter-barrier spacing may be the same as perforation distribution along the elongate axis.

The walls or barriers may act as a heat exchanger. They are thermally conductive when the support surface contains metal.

The planar support also acts as a substrate onto which catalysts can be supported.

Cultivating the substrate may start with heat treating a metal substrate to form non active oxide layer texture with an uneven surface to increase the surface area for the seeding process. The surface texture may be alumina whiskers.

The substrate may be populated with catalytic seeds for carbon growth.

The catalytic seeds may be carried via a fluid liquid or a gas or a combination thereof and spread through one or multiple perforated vessels on the substrate. The fluid may enter under pressure ranging from atmospheric pressure or to below 100 atm (e.g., 0.0001 atm to 15 atm)

During seeding, one or multiple of perforated vessels may carry liquid and the other perforated vessel carry hot gas selected from steam, inert gas such as N₂, He, Ar, or hydrocarbon such as CO₂, C₁, C₂, C₃, or a reducing gas such as CO, H₂ and the combination thereof.

Prior to seeding, a passive layer may be formed on the inner surface of outer vessel. The passive layer may be created on outer or inner surface of the perforated vessels to prevent deposition of seeds and growth of carbon on unwanted surfaces. Passivation maybe performed on outer or inner surface of the perforated vessel in a same or different method. Passivation maybe through surface treatment such as micro polishing, or surface oxidation to minimize physical anchors. Passivation maybe through deposition of another layer such as paraffin wax layer to reduce the wettability of surface and seeds fluids.

The catalytic seeds may be a precursor containing metal from group VIII including Fe, Ni, Cu, Zn, Co and Mo, and the combination thereof.

The support may be populated with catalytic nanoparticles (nP). The spacing between neighbouring nanoparticles may be on the same order of magnitude as the diameter of the nanoparticles. That is, the average closest approach between neighbouring nanoparticles may be between 0.1-10 times the average diameter of the nanoparticles.

The support surface may comprise a non-active layer towards carbon formation which holds the active nanoparticles such as Fe, Ni, Mg, Cr, Cu, Zn, Mo, Co, and Mn well distributed. The non-active layer is generally composed of oxide materials such as alumina, chromia, zirconia, silica, or a combination thereof. In some embodiments, this non active layer is composed of alumina and zirconia whiskers which are textured in 3D, and forming an uneven surface. The terracing feature is providing a physical barrier between nanoparticles (nPs), separating active metals and preventing them from sintering and grain growth during heat treatment and reaction. Carbon nanofibers grow on active sites containing nanoparticles of the metals Fe, Ni, Mg, Cr, Cu, Zn, Mo, Co, and Mn and combinations thereof. The whiskers may comprise alumina. The whiskers may comprise zirconia.

Alumina whiskers act like a cage and ensure the deposition of active metals well distributed, it avoids them moving at temperatures causing excessive mobility of the nanoparticles that sinter them (coalescence) (Tammann temperature). Alumina whiskers may be in the form of plates with at least one extended dimension between 0.5-10 μm and at least one thickness dimension between 10-500 nm. These whiskers form cages of less than around 0.2-10 μm which restricts the movement of the deposited nanoparticles of catalyst across the bulk surface.

The Tammann Temperature: (for bulk diffusion) may be considered to be the temperature at which the atoms or molecules of the solid acquired sufficient energy for their bulk mobility to become appreciable (e.g., to allow sintering). The Tammann temperature is typically around one-half of melting point in Kelvin. The surface-diffusion temperature may be considered to be the temperature at which the atoms or molecules can migrate on a surface.

Active metal terracing also keeps CNF individually separated and allowing them to elongate with supressed tangling effects. In some embodiments, the nanoparticle size varies below 10 nm or below 20 nm, below 35 nm or below 50 nm. In some embodiments, the nanoparticles are below 100 nm. These upper bounds may correspond to the maximum dimension of the nanoparticles (e.g., measured by scanning electron microscope or other imaging). The Dv10 of the nanoparticles may be greater than 1nm and/or the Dv90 may be less than 100 nm, where D is the maximum dimension of the nanoparticles, and the sizes are based on a volume distribution. Terracing and whiskers of the supporting surface in general add a third dimension to provide a higher spread of catalytic nanoparticles while increasing the load with respect to more planar support structures. Example of surface area of the disk vs. Surface area after whiskers development.

The support may comprise iron-aluminium (e.g., FeCrAl) alloy. The alloy may comprise at least 1% aluminium by number. The support may comprise Aluchrom™, Kanthal AF™, Kanthal APM™, Nisshin steel Ugine Savoie 12178™.

Using FeCrAl may be advantageous for a number of reasons. The support may be heat treated to form the alumina whiskers which can be used to restrict the motion of the deposited nanoparticles. This may allow the catalyst to selectively produce nanofibers because the size and distribution of the catalyst nanoparticles are controlled. The support is also metallic which may allow the support to be bent into shape (e.g., into corrugations to increase the surface area). The support may also be heat conducting. This may be important for its use in conjunction with exothermic reactions. That is, heat can be quickly distributed to prevent hot spots from forming, and to allow heat to be transferred from one reactor to another. The support may be magnetic to facilitate loading nPs (providing a physical bond before heat treatment and formation of a chemical bond).

The reaction assembly may comprise a cooler for extracting heat from the support surfaces (e.g., during carbon nanofiber production). The cooler may comprise a heat exchange, cooling fins and/or a refrigeration unit (e.g., with a heat pump). The reaction assembly may comprise a heater for heating the support surfaces (e.g., when seeding or preparing the catalyst). The heater and/or cooler may be connected to a components which is in thermal communication with the support surfaces.

The support may be corrugated or roughened to increase the surface area.

The diameter of the nanoparticles may be between 10-150 nm.

The support may comprise a metallic substrate.

The precursors containing seeds for carbon growth may be annealed and reduced to form a lower oxidation state of active site prior to flowing reactants.

The reaction to form carbon nanofibers may be considered selective if more than 60% of the carbon formed by mass is in the form of carbon nanofibers (e.g. rather than graphite or amorphous carbon.)

The reactor design maybe used to form solid carbon with other carbon-containing molecules such as hydrocarbons, C₁, C₂, C₃, C₄, ethylene, benzene. The reactor design may be used for other gas to solid carbon reactions such as pyrolysis.

Unless listed otherwise, ratios given in this disclosure may be taken as number ratios. For example, a H₂:CO ratio of 0.5 means that there are two carbon monoxide molecules for every molecule of hydrogen.

After sufficient time allowing growth of carbon nanofibers, a harvesting process is to be initiated using one or more fluids entering the vessel through one or multiple conduits.

One or more conduits may carry fluids with different velocity to provide energy (momentum) that causes detachment of the CNFs from the alumina whiskers substrate. One perforated tube may carry liquid and the other may carry a gas for improving the turbulent mixing process. One or more conduits may include specially designed orifices, i.e., nozzles, to spray the harvesting liquid over the planar substrate. The harvesting fluid might be gases such as air, inert gases or liquids such as water, alcohols, polyols, amides, phospholipids, oligosaccharides, polysaccharides, monosaccharides or a combination thereof. Fluids are selected based on their fluid properties (e.g., to facilitate effective harvesting without damaging the product) and so as not to leave any residue which could harm the reaction or product quality in the reactor.

After certain time of mixing the vessel may be drained from the fluid containing the CNFs. The process may be repeated until substantial harvest or extraction of CNFs from the vessel (e.g., over 50% by mass of the CNFs).

The outer vessel may contain a drainage pass for removal of the highly concentrated liquid. During the harvesting period, the vessel may be angled to accelerate drainage with the help of gravity. The vessel may have a convex shape.

Prior to harvesting CNF, oxidizing agent in combination with increasing temperature may be used to remove non-crystalline carbon or to partially oxidize the surface of carbon nanomaterials.

Prior to harvesting, the surface of carbon might be functionalized using hydroxyl, carboxyl, phenyl, etc. groups prior to harvesting.

During harvesting period, temperature may rise to accelerate and enhance mixing.

After certain harvesting cycles, the temperature may rise again to remove non harvested carbon from the reactor.

In connection with repeating the process of cultivating, seeding, planting, and harvesting of carbon nanofibers any of the steps may be repeated after single or multiple operation.

This disclosure also relates to a reactor design for seeding active sites on a microscopically roughened substrate, growing carbon nanofibers on the active seeds, harvesting carbon nanofibers, preparing the substrate for the next replenishment, and reinjecting or reactivating seeds on the substrate in the reactor.

The CNF diameter may be between 10 nm to 200 nm, the length may be from 1μm to a few dozens of μm (e.g., up to 100 μm). CNF thus produced may have a solid core, which is composed of graphene layer that they may be aligned parallel, perpendicular or with an angle to the fiber axis. Empty core fibers that are alternatively called carbon nanotubes are made of 1 or several coaxially rolled graphene layer. CNFs produced may have one or more of the forms described with extremely different proportions. After harvesting, the substrate may need to be loaded with catalyst nanoparticles again.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIGS. 1a and 1b are respectively a lateral cross-sectional view and a perspective cut-away view of a first embodiment of a reaction assembly.

FIGS. 2a and 2b are respectively a lateral cross-sectional view and a perspective cut-away view of a second embodiment of a reaction assembly.

FIG. 3 is a lateral cross-sectional view of a third embodiment of a reaction assembly.

FIG. 4 is a flow diagram showing how carbon nanofibers may be grown according to a further aspect of the present disclosure.

FIGS. 5a and 5b are respectively a lateral cross-sectional view and a perspective cut-away view of a fourth embodiment of a reaction assembly.

### DETAILED DESCRIPTION

### Introduction

Various aspects of the invention will now be described with reference to the figures. For the purposes of illustration, components depicted in the figures are not necessarily drawn to scale. Instead, emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments of the present invention.

One issue that the inventors have identified with existing reactor systems is that the partial pressure of the reactants is generally higher in spots closer to the reactants entrance point and gradually reduces through the catalyst bed towards the exit of the reactor. This phenomenon results in nonhomogeneous flow distribution throughout the reactor and pressure differences throughout the reactor, preventing the gas exposure to the fresh catalyst and, in severe cases, blockage of the reactor at the entrance of the catalyst bed. In addition, catalyst supports in the form of a monolith, honeycomb or foams provide limited space for growth of carbon, and once carbon accumulated in the structure, it will be compacted and difficult to be harvested.

As described above, these issues have been addressed in the past by increasing the size of the reactor, excess flow, and low amount of catalyst, all of which can result in low efficiency and low yield of the process.

To address the inefficiency of the process, a new reactor design is suggested to help with one or more of the following:
enhancing mass transfer and heat transfer in carbon production process;
sustaining a uniform distribution of the reactant gas throughout the reactor; and
providing a method for harvesting the product and replenishing the catalyst in the reactor.

The present reactor design uses distributed openings and barriers to control the flow of the reactant gases with respect to the solid catalyst. The space between consecutive barriers serves as a smaller chamber (a sub-chamber or reaction module) that could provide a homogenous velocity of reactants. During the growth phase where gaseous reactants are being converted into solid product, flow regimes are more uniform across the catalyst surfaces. The configuration may also help provide uniform and efficient heat transfer, including in adiabatic and/or iso-wall heat transfer during operation.

The reaction converts gas into a solid which is associated with a pressure drop due to the differences in density between the reactants and products. Having the inlets distributed spatially means that the partial pressure is more homogenous across the catalyst support surfaces in a smaller sub-chamber reaction zone. With the manipulation of nozzles size, distance, distribution, and the clearance space (the gap between the disks and the outer body), a laminar flow may be created in every modular section. When carbon grows in every section, it does not block the gas passage, such as occurs typically in the reactors with one inlet. A clearance gap may also allow the recycling of the gases from one module to the other module and maximizes the conversion rate.

The operation can be automatically performed so a production system comprises a set of alternating reactor assemblies that will have some of them performing the CNF growth, while others are being submitted to the CNF harvesting and re-initiation by cutting out the fibers and re-impregnating and activating the support surfaces to get back into CNF growth. The catalysts impregnated onto the support surfaces of these reactor assembly allow the production of carbon nanofibers of high quality already at temperatures in the range 400-690° C., more preferably in the range 450-580° C.

### Chemical Reactions

Regarding the chemical reactions, this apparatus may be used to catalytically convert gaseous CO (Carbon monoxide) and hydrogen into solid carbon in the form of carbon nanofibers and water (as vapour and/or liquid water) as per the ensuing reaction:

2CO+2H₂→2C+2H₂O, ΔH°₂₉₈=−264 kJ

The reactants may be obtained from, for example, dry reforming of methane (DRM). Produced water at elevated temperature of the reaction, exit from the reactor in the form of steam.

As will be discussed further below, the H₂—CO blend is flowed through a reaction chamber containing nanoparticles of Fe, Ni, Mg, Cr, Cu, Zn, Mo, Co, and Mn and combinations thereof. These nanoparticles catalyze the growth of carbon fibers from the H₂—CO mixture thus producing the solid CNF material.

It will be appreciated that, under industrial conditions, these reactions are mostly implemented irreversibly. Nevertheless, aspects of this technology relate to how unreacted reactants can be reprocessed and recycled to improve efficiency, which is of conventional knowledge on chemical processes design.

The H₂:CO number ratio may be configured to be at least 0.3 (e.g., at least 0.7 or 0.8). The H₂:CO ratio may be configured to be at most 1.3 (e.g., at most 1.2 or 1.05) Changing the H₂/CO ratio to high values may yield undesirable carbon type and mechanisms (Boudouard reaction is undesirable) moving it to low values may waste hydrogen.

High CO or lack of H₂ favours a high rate of C deposits via Boudouard reaction, which may conduce to massive graphitization forming carbon blacks and fibres instead of nano fibres, and thus a lower selectivity to higher value product. That is, the reaction is primarily to amorphous forms or, depending on T and residence time, to fibers and graphite. Therefore, an important aspect of the present invention is ensuring that the temperature and flow rate across the surface of the catalyst is consistent across the catalyst support surfaces. Otherwise, sections of the catalyst support surfaces may experience conditions favourable to producing carbon nanofibers while other sections may experience conditions favorable to producing other non-desired forms of carbon such as amorphous forms.

A high proportion of CO favours a process which is less selective to carbon nanofibers. A high H₂ proportion yields slower carbonization and it typically favours graphitization and fiber production, particularly at high T (which is needed to accelerate the rate of reaction given the low partial pressure of CO). Furthermore, a low partial pressure of CO reduces mobility of adsorbed C (from decomposition of CO on the surface of the nanoparticle) which reduces the rate of diffusion of C through the nanoparticles, an important factor needed to build the nanofibers. Therefore graphene/graphite tends to be produced (rather than carbon nanofibers) with a higher proportion of H₂.

The energy balance is exothermic, thus resulting in energy production. This heat should be distributed evenly within the reaction chamber. The present design also facilitates heat removal through the support surfaces and conduits. This may help maintain the desired temperature within the reaction chamber, and allows the excess heat to be used elsewhere (e.g., to provide heat for an endothermic precursor reaction).

The H₂/CO ratio as well as other process and catalyst condition is adjusted to maximize decomposition of syngas to high purity carbon nanofibers and largely reduce the possibility of a Bosch reaction, a Boudouard reaction, and a methane formation reaction as previous art teaches. The non-selective nature of these reactions will generally result in the formation of large combination of different allotropes of carbon solid products.

For the reaction of carbon monoxide and hydrogen to form to carbon nanofibers (CNF)), the reaction is conducted using a supported catalyst. In this embodiment the catalyst is a nanoparticulate anchored onto the alumina whiskers formed at the parallel walls described.

Oxide whiskers on the support surface for the catalyst makes the surface uneven allowing for high load of catalyst nanoparticles with good distribution. Nanoparticles of transition metals have high tendency to migrate at high temperatures (60% of the Tammann temperature in Kelvin), forms necks with the neighbors, sinter and eventually form bigger particles. Providing a textured surface for nanoparticles may make it easier to control the distance of active nanoparticles and/or to control the diameter of carbon nanofibers.

The whiskers layer may be formed by directly on an appropriate metallic substrate. This may allow the support layer to be more malleable. It may also improve how heat can be conducted away from the whiskers.

Terracing or texturizing the substrate add an additional dimension to the substrate and facilitate to anchor the catalyst nanoparticles at the nano-metric level to the substrate site. This is an advantage over growing CNF on a flat surface or stainless-steel wool which may reduce the selectivity toward carbon nanofibers growth and result in a large variety of carbon forms including graphite, microfibers and amorphous carbon which are not as valuable as CNF.

The chemical bond between alumina and the catalyst nanoparticles modifies the reduction profile of the catalyst nanoparticles and retains the active site size in nano range.

The support may be formed of iron alloy containing 5% Al by weight. In some embodiments, the support may contain less than 10% Al by weight. The active catalyst may be Fe, Ni, Mg, Mn, Co, Cr, W, Ti and Zn or combinations of them.

The support may be heat treated at temperature between 700-1000° C. for 5-48 hours to enable formation of Al₂O₃ whiskers on the surface and make the support surface uneven to maximize sustaining the catalyst particles on the support. This heat treatment may be considered as a cultivation step where the support surface is prepared to receive the catalyst particles.

In some embodiments, the catalyst precursor deposited on the support, heat treated and reduced with CO, H₂, or combinations of them diluted with an inert gas, Ar, He, and N₂ at a temperature between 500-800° C. for 2 to 48 hours. This is part of the seeding step.

In accordance with another aspect, the supported catalyst is designed in a way that carbon containing-gases (CO, CO₂ and light hydrocarbons from C1 to C4) can pass with ease through the reactor hot zone and supported catalyst during a significant period of time, until the structured element gets fully charged with CNF and can be harvested from the produced CNF material.

### Joined Sub-Chamber Embodiment

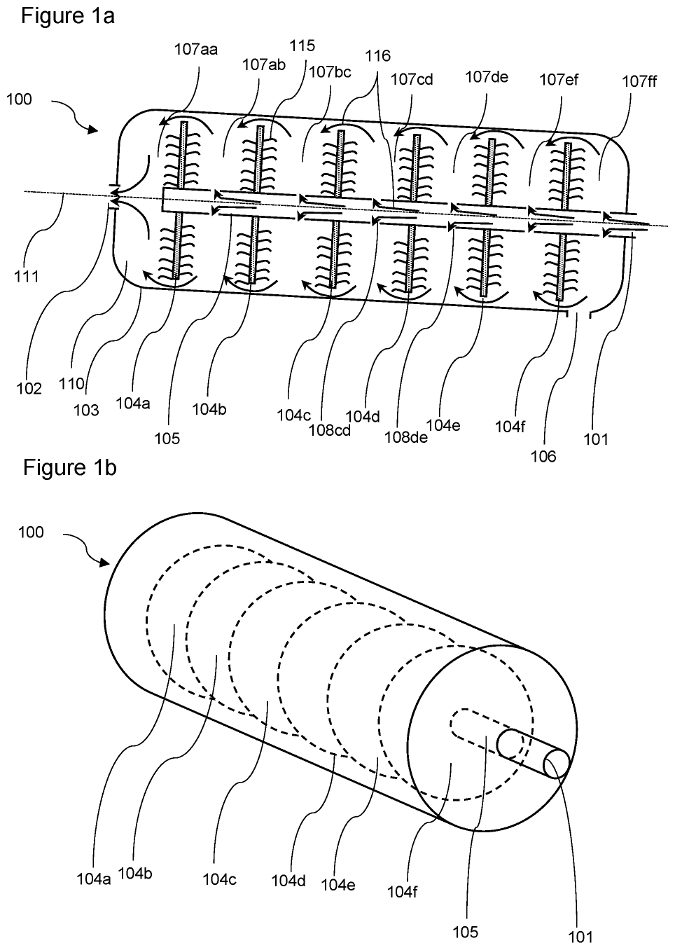

FIGS. 1a and 1b shows an embodiment of a reaction assembly 100 comprising:
an inlet 101;
an outlet 102;
an elongate vessel 103 defining a reaction chamber 110 in fluid communication with the inlet 101 and the outlet 102;
one or more planar supports 104a-f within the reaction chamber, the one or more planar supports having surfaces for supporting a solid catalyst, and being mounted transversely to, and forming a series of spaced-apart barriers along, an elongate axis 111 of the vessel; and
a conduit 105 positioned within the reaction chamber 110 and connected to the inlet or the outlet, the conduit comprising conduit openings (e.g., openings 108cd, 108de) positioned between successive barriers, such that gas flow from the inlet 101 to the outlet 102 causes gas to flow through the conduit 105 and through the reaction chamber 110 along the support surfaces between successive barriers.

In this case, the reaction assembly 100 comprises multiple planar supports 104a-f, each planar support being a circular vane spaced apart along a centrally positioned conduit 105. In this case, the conduit 105 is coaxial with the outer elongate vessel 103. The planar supports are mounted to the conduit in this case. The conduit goes through the planar supports.

Each planar support 104a-f forms a corresponding spaced-apart barrier. Each volume between each pair of successive or adjacent barriers may be considered as a sub-chamber 107aa, ab, bc, cd, de, ef and ff. The sub-chamber letters are based on the letters of the two bounding planar supports/barriers. For example, sub-chamber 107ab is positioned between planar supports or barriers 104a and 104b. Sub-chambers with double letters form a sub-chamber with the end of the vessel. For example, sub-chamber 107ff is positioned between planar support or barrier 104f and the end of the vessel 103.

In this case, the conduit 105 is connected to the inlet 101. When reactants are injected into the conduit through the inlet 101, gas is introduced into each of the sub-chambers 107aa-ff between successive planar supports through a series of conduit openings (e.g., perforations, holes or nozzles) provided along the length of the conduit.

In this case, the planar supports 104a-f have a diameter smaller than the inner diameter of the elongate vessel 103. This means that there is a gap between the outer edges of the planar supports 104a-f and the interior surface of the wall of the elongate vessel 103. This allows any gas which is not converted into a solid or gas within one sub-chamber to pass into the next sub-chamber through the gap and eventually out of the vessel through the outlet 102. Because, in this embodiment, the supports are directly 104a-f connected around the conduit 105, gas passing from the conduit openings to the outlet must pass radially along the support surfaces of the planar supports 104a-f, where the solid catalyst is mounted.

The solid catalyst in this case is configured to facilitate the conversion of the gaseous reactants into solid product. It will be appreciated that the conversion of gaseous reactants to a solid or liquid product will be associated with a significant density change. Therefore, the reaction itself will cause a lowering of the pressure within the vessel as the reactant gas moves across the catalyst. This embodiment compensates for this by having a variety of paths throughout the reaction chamber 110. Openings such as 108cd and 108de (for clarity, not all openings are labelled) along the conduit allow reactant gas to be introduced into the reaction chamber at a range of points along the elongate vessel length. This means that the reactants can be distributed evenly across the catalyst surface. In this case, there is at least one conduit opening positioned between each pair of adjacent supports. In addition, there is a conduit opening between the support 104f closest to the inlet 101. At the distal end of the conduit, away from the inlet, the conduit is closed, and there is no conduit opening between the support farthest away from the inlet 104a and the end of the vessel 103.

In this case, the vessel 103 has a uniform cross-section across the multiple barriers 104a-f along the length of the elongate axis. Simulations of this structure have shown that this allows each of the sub-chambers to have a consistent pressure. The first sub-chamber 107ff receives gas only from the conduit 105. Subsequent sub-chambers 107ab-ef receive progressively less gas from the conduit in this embodiment, but also receive any unreacted gas from previous sub-chambers which serves to make up the difference in pressure as shown by the arrows showing gas flow within the reaction assembly.

In the event that there is uneven solid product production within the reaction chamber, distributing the openings along the length of the conduit means that any blocking or drag effect of the uneven growth may be mitigated. For example, if the second sub-chamber grew more rapidly initially because it was receiving a greater flow of reactant gas, the growth of the solids may cause a restriction in gas flow through that sub-chamber. However, rather than blocking flow for the whole assembly, the reactant gas flow would automatically adjust to be redirected through other sub-chambers with a lower resistance (i.e., less blocked or lower drag). This would accelerate the solids production in the less developed sub-chambers to help generate even growth across the whole catalyst surface.

In this case, the surfaces carry nano-catalysts for converting the gaseous reactants 116, hydrogen and carbon monoxide, into carbon, in the form of carbon nanotubes 115, and steam. This configuration allows the carbon nanotubes to be grown evenly across the support surfaces as the partial pressures of the reactants is kept consistent throughout the reactor vessel.

To facilitate growth of carbon nanofibers, the support surfaces are spaced apart by at least 1 mm (e.g., in a direction normal to the support surfaces). This allows the carbon nanofibers to grow without creating a matrix which restricts the flow of reactant gas through the sub-chambers.

The support surfaces are thermally conductive and constitute heat transferring interior walls all contacting the central gas aspersion tube thus forming a robust heat exchanger. The reaction to convert hydrogen and carbon monoxide into carbon and water is exothermic, and so inherently generates heat. The support surfaces are formed from a single sheet, and so the heat generated by the reaction can be distributed easily throughout the reactor vessel. In this embodiment, the support surfaces, as mentioned, are all connected to the conduit which is also thermally conductive. This allows heat to be extracted from the support surfaces via the central conduit through conduction in this case. The central conduit may also internally be the place where a precursor reaction, such as the dry reforming of light hydrocarbons with CO₂ to be converted into CO and H₂. This way the heat from the carbonization section can be transferred to the dry reforming reactor, allowing an internal endothermic process capturing the excess heat of carbonization. In addition, if required, heat can be supplied to the support surfaces in this embodiment by heating the central conduit. The temperature of the surfaces can also be determined using a thermocouple or other thermometer attached to the conduit.

The vessel in this case comprises a drainage exit 106 for removing liquids (and any entrained solids). By having the reactant conduit raised above the bottom of the vessel, these non-gaseous components can fall below the reactant conduit and so not block fluids being introduced into the reaction chamber. This embodiment is also configured to be tilted to direct liquids towards the drainage exit. It will be appreciated that other embodiments may be configured to have a sloped bottom. The drain may also be used when harvesting the solid product.

During harvesting a liquid containing water may be injected into the reactor after reaction termination in the reactor. The reaction might continue in parallel reactors while we are harvesting the CNF products and prepare the catalyst for the next run.

### Multiple Conduit Embodiment

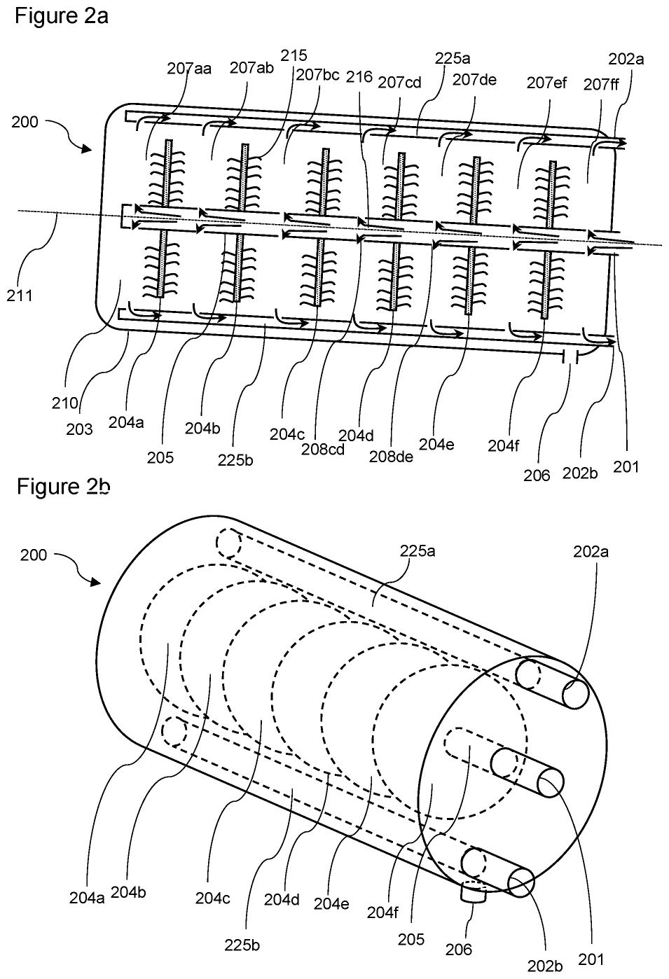

FIGS. 2a and 2b shows an embodiment of a reaction assembly comprising:
an inlet 201;
multiple outlets 202a,b;
an elongate vessel 203 defining a reaction chamber 210 in fluid communication with the inlet and the outlet;
one or more planar supports 204a-f within the reaction chamber, the one or more planar supports having surfaces for supporting a solid catalyst, and being mounted transversely to, and forming a series of spaced-apart barriers along, an elongate axis 211 of the vessel; and
a conduit 205 positioned within the reaction chamber and connected to the inlet or the outlet, the conduit comprising conduit openings positioned between successive barriers, such that gas flow from the inlet to the outlet causes gas to flow through the conduit and through the reaction chamber along the support surfaces between successive barriers.

As in the previous embodiment, the reaction assembly comprises multiple planar supports, each planar support being circular vanes spaced apart along a central conduit. In this case, the conduit is coaxial with the outer vessel. Each planar support 204a-f forms a corresponding spaced-apart barrier. The volumes between each pair of successive or adjacent barriers may be considered as a sub-chamber 207aa, ab, bc, cd, de, ef and ff.

Unlike the previous embodiment, this embodiment has an inlet conduit 205 for injecting reactant gas into the reaction chamber and multiple outlet conduits 225a,b for removing gas from the reaction chamber. In this case, the inlet and outlet conduits 205, 225_{a,b} comprise multiple openings 208cd,de spatially distributed between adjacent barriers along the length of the reaction chamber 210. This allows for a more uniform gas flow within each sub-chamber.

Conduits 225a,b are also employed for the seeding and harvesting phase. They can be used to flow reactant, fluid containing nano catalyst and/or harvesting fluid. The main purpose of having them is to have access to the surface of disks.

It will be appreciated that the addition of outlet conduits allow gas to be extracted directly from each sub-chamber. This means that less gas passes from sub-chamber to sub-chamber compared with the previous embodiment. This helps to ensure that each of the sub-chambers experience the same relative concentrations of reactants.

As before, the reactor is configured such that when the reactants 216 pass over the solid catalyst mounted on the support, carbon nanofibers 215 are grown.

It will be appreciated that other embodiments may comprise one or more than two outlet conduits. In other embodiments, the support surfaces may be connected to the one or more outlet conduits.

As with the previous embodiment, the vessel in this case comprises a drainage exit 206 for removing liquids (and any entrained solids). By having the conduits raised above the bottom of the vessel, these non-gaseous components can fall below the reactant conduit and so not block gases being introduced into the reaction chamber. The drain may also be used when harvesting the solid product.

### Enclosed Sub-Chamber Embodiment

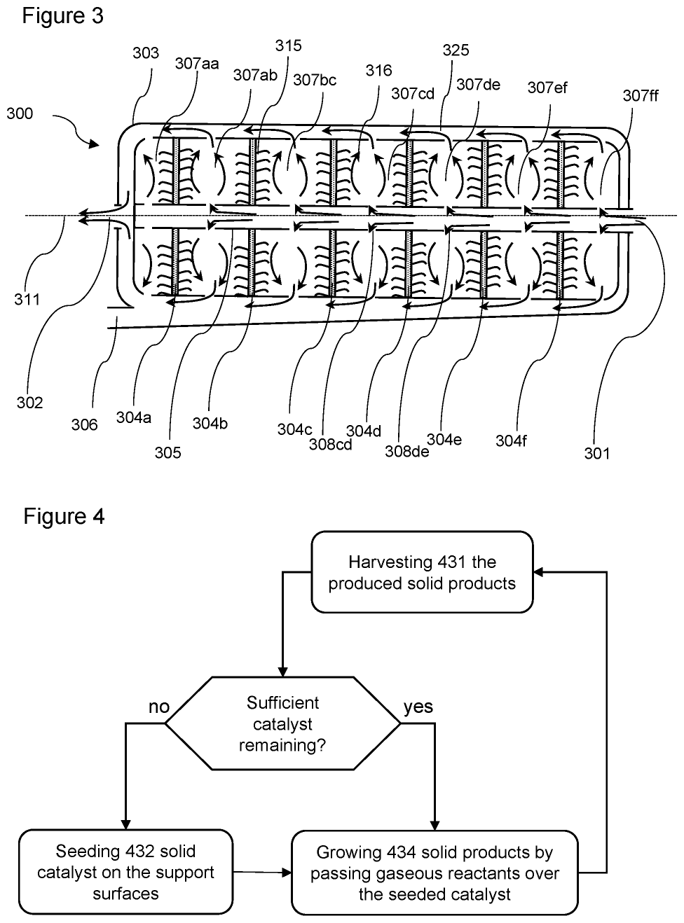

FIG. 3 shows a further embodiment of a reaction assembly comprising:
an inlet 301;
an outlet 302;
an elongate vessel 303 defining a reaction chamber in fluid communication with the inlet and the outlet;
one or more planar supports 304a-f within the reaction chamber, the one or more planar supports having surfaces for supporting a solid catalyst, and being mounted transversely to, and forming a series of spaced-apart barriers along, an elongate axis 311 of the vessel; and
a conduit 305 positioned within the reaction chamber and connected to the inlet or the outlet, the conduit comprising conduit openings 308cd,de positioned between successive barriers, such that gas flow from the inlet to the outlet causes gas to flow through the conduit and through the reaction chamber along the support surfaces between successive barriers.

As in the previous embodiment, the reaction assembly comprises multiple planar supports, each planar support being circular vanes spaced apart along a central conduit. In this case, the conduit is coaxial with the outer vessel. Each planar support forms a corresponding spaced-apart barrier. The volumes between each pair of successive or adjacent barriers may be considered as a sub-chamber 307aa, ab, bc, cd, de, ef and ff. In this embodiment, the reaction chamber is made up of a series of discrete sub-chambers where fluid flow between the sub-chambers is prevented by the barriers.

Unlike the previous embodiment, this embodiment has an inlet conduit 305 for injecting reactant gas into the reaction chamber and an annular outlet conduit 325 surrounding the reaction chamber. That is, the elongate vessel in this case has a hollow wall, the inner wall forming the outside of the reaction chamber, and the outer wall forming the exterior of the vessel. Openings in the inner wall positioned between successive supports allow gas to be removed from each sub-chamber and directed towards the outlet 302. The inner wall helps guide gases exiting each reaction chamber to the outlet without entering other reaction chambers along the way. It will be appreciated that, in embodiments where this inner wall is absent (such as the embodiments of FIGS. 1a, 2a and 5a), gases may exit from one reaction sub-chamber and pass into another sub-chamber (e.g., a sub-chamber closer to the outlet). This may help maintain a consistent pressure throughout the elongate vessel.

In addition, the bottom surface of the lower wall is sloped towards a drain 306 for removing liquid from the reaction chamber (and any entrained solids). It will be appreciated that the drain may be sealable or comprise a liquid trap so that exiting gas can be directed to the outlet rather than escaping via the drain exit. In this embodiment the drain 306 is positioned at the same end of the vessel as the gas outlet 302 so that air flow towards the outlet encourages the liquid towards the drain. The drain may also be used when harvesting the solid product.

As before, the reactor is configured such that when the reactants 316 pass over the solid catalyst mounted on the support, carbon nanofibers 315 are grown.

### Process Cycle

As shown in FIG. 4, reactor assemblies described herein may help facilitate a cyclic process in which solid catalyst or seeding particles is distributed on the support surfaces (seeding 432); gaseous reactants are converted to solid products (growth 434); and the solid products are extracted (harvesting 431) without the need to open the reactor vessel and/or remove the support surfaces from the vessel.

Each of processes may be performed using fluids passing through the reactor vessel. These fluids may include gases, liquids, and/or particulate solids entrained in gases or liquids. In addition, the processes may be performed while subjecting the reaction chamber to different environmental conditions. Changing the environmental conditions may include one or more of: changing the pressure, tilting the reaction assembly, subjecting the reaction assembly to mechanical or ultrasound waves.

Seeding involves injecting the catalyst using a fluid containing particles through nozzles. The nozzles may be the openings in one or more of the conduits described above, or separate nozzles. The nozzles are spatially distributed within the vessel to allow the catalyst to be spread evenly on the support surfaces uniformly without the need to disassemble the reactor. Typically, there would be at least one nozzle for injecting catalyst between each pair of adjacent barriers. In some embodiments, there may be multiple conduits with one or more of the conduits being used to inject dispersed catalyst, and one or more other conduits being used to introduce a hot gas into the reaction chamber to anneal the catalyst and create a chemical bond to the substrate.

Seeding may comprise a cultivation step in which the substrate is prepared to receive the catalyst seeds. Cultivation may comprise heat treating a metal substrate to form non active oxide layer texture with an uneven surface to increase the surface area for seeding process. The surface texture may comprise alumina whiskers. Cultivation may comprise heating to remove product remnants of previous reactions (e.g., to remove previously grown carbon nanofibers which were not removed during a harvesting stage). Cultivation may or may not be part of the seeding step in every cycle.

The nozzle diameter, numbers and distribution in combination with the properties of fluid containing seeding particles can be manipulated to create an optimum coating efficiency and reduce the waste of catalyst preparation.

During seeding, a flow of gas may be maintained into the reaction chamber through one or more of the other conduits (i.e., of the ones not being used for seeding particle carrier). This helps to direct catalyst particles away from the openings in the conduits which will prevent them being blocked by the catalyst particles themselves or the solid product which may grow on such catalyst particles.

Depending on the nature of the catalyst, seeding may also comprise an activation stage. The catalyst may be activated by changing the nature of the catalyst precursor to form an active catalyst. Activation may be achieved by changing the physical structure of the catalyst precursor (e.g., by heating to control particle size or to anneal the precursor) or chemically changing the catalyst precursor (e.g., by reacting with a reducing agent to change the oxidation state of the precursor to form the activated catalyst).

Seeding may also comprise controlling surfaces within the reaction chamber which should not be seeded. For example, in some embodiments, the vessel walls and the outer surfaces of the conduits may be treated so that catalyst particles injected during the seeding stage do not stick to them. This ensures that solid product production is limited to the support surfaces.

Growth of the solid product has been described. Growth involves injecting gaseous reactants into the reaction vessel such that the reactants pass over the solid catalyst mounted on the support surfaces. The catalyst facilitates the conversion of the gaseous reactants into a solid product (e.g., carbon nanofibers) and possibly other products (e.g., gaseous products like water vapour, or liquid products like liquid water).

Growth may also comprise a finishing stage in which the grown nanofibers are processed in situ prior to harvesting. Finishing may include remove non-crystalline carbon or to partially oxidize the surface of the carbon nanomaterials. This may involve injecting an oxidizing agent into the reaction chamber and/or increasing the temperature.

Finishing may include functionalizing the surface of carbon with, for example, hydroxyl, carboxyl, phenyl, etc. groups prior to harvesting.

Harvesting is performed by creating adequate physical force to dislodge the solid from the surface and to deagglomerate the particles.

This may happen through providing energy input in a localized form such as shock wave effect, micro-jet effect, cavitation, friction, shearing, and thermal effect. The design of perforated and disks (modular zone) allow for spreading liquid in a larger area, penetrating fluid in cavities and macroporosities to loosen the soft agglomerates.

A combination of liquid and gas can be entered into the outer vessel through several perforation inlets lines. This may help intensify the local physical force for the deagglomeration of particles and dispersion within the liquid. For example, the mixture of liquid and gas may allow bubbles to form which can be used to dislodge the carbon nanofibers from the solid catalyst. The liquid for harvesting can be a wide variety of solutions such as water-based, hydrocarbon-based, and alcohol-based. Ultrasonic force, natural resonance force, and oscillation may be used in combination to improve mixing.

Once the solid and liquid mixture has been removed from the vessel, the liquid and solid (e.g., filtration evaporation and/or cyclonic separation) can be separated to provide the dry solid product.

The growth stage and/or the harvesting of the solid particulate may dislodge some of the solid catalyst from the support surface. For example, in carbon nanofiber production, the carbon nanofiber may grow away from the catalyst particulate or the carbon nanofiber may grow between the catalyst particle and the support surface. In the latter case, where the catalyst is attached to the free end of the carbon nanofiber, harvesting the solid nanofiber product also removes the catalyst particulate. Likewise, the forces generated by the harvesting stage to remove the solid product may also remove some of the solid catalyst. This means that the catalyst may need to be reseeded periodically.

It will be appreciated that reseeding may or may not need to be carried out after every harvesting step. For example, depending on how quickly the reseeding may be carried out, it may still be more efficient to carry out several growth and harvesting cycles before reseeding even if the effectiveness of the reaction diminishes as catalyst is progressively removed from the support surfaces. Once the depletion of the catalyst is known for a particular process, the reseeding step may be scheduled for every N growth and harvesting cycles, where N is an integer number.

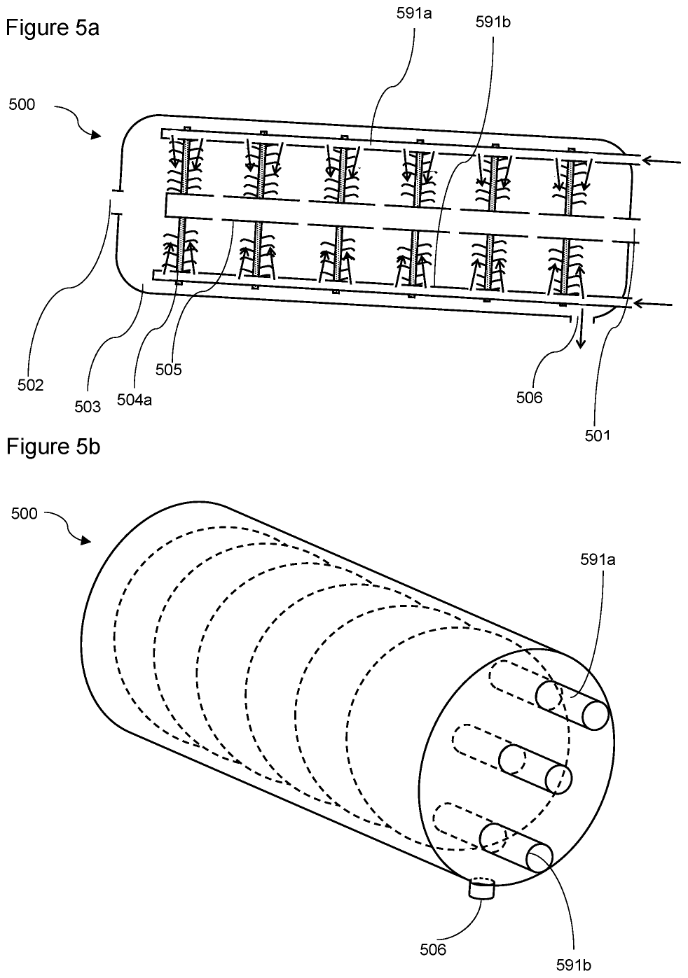

FIGS. 5a and 5b shows an embodiment of a reaction assembly 500 with additional harvesting conduits. This embodiment is similar to the embodiment of FIG. 1a and comprises:
an inlet 501;
an outlet 502;
an elongate vessel 503 defining a reaction chamber in fluid communication with the inlet and the outlet;
one or more planar supports (e.g., support 504a) within the reaction chamber, the one or more planar supports having surfaces for supporting a solid catalyst, and being mounted transversely to, and forming a series of spaced-apart barriers along, an elongate axis of the vessel; and
a reactant conduit 505 positioned within the reaction chamber and connected to the inlet or the outlet, the conduit comprising conduit openings positioned between successive barriers, such that gas flow from the inlet to the outlet causes gas to flow through the conduit and through the reaction chamber along the support surfaces between successive barriers.

In this case, there are additional harvesting conduits 591a-b configured to carry harvesting fluid (e.g., a liquid). In this case, each harvesting conduit is positioned adjacent to the outer wall of the elongate vessel. The harvesting conduit comprises nozzles configured to inject the harvesting fluid along (and/or slightly towards, e.g., impinging the support surfaces at an angle of less than) 30° the support surfaces of the barriers in order to shear off the produced carbon nanofibers (e.g., towards the base of the produced carbon nanofibers adjacent to the support surface). In this case, the nozzles are directional preferentially directing fluid flow in a direction aligned with the plane of the support surface.

In this embodiment each support surface is associated with a respective directional nozzle positioned close to the support surface. This helps ensure that the liquid is directed to the base of the growing nanofibers to help shear them from the support while reducing damage to the nanofibers.

The nanofibers are removed from the vessel with the harvesting fluid at drain 506 after which they can be separated from the harvesting fluid.

It will be appreciated that other embodiments may have only one or more than two harvesting fluid conduits. When using liquid harvesting fluids, the one or more harvesting conduits may be positioned towards the top of the vessel when harvesting. This configuration allows the liquid to be injected downwards so that the flow direction within the vessel is aligned with gravity.

In some embodiments, the harvesting conduit may be the same as the reactant conduit. In some embodiments the harvesting conduit may be used to seed the catalyst in the seeding stage. This may be advantageous where the nozzles are directed along the support surfaces.

### Other Options

The reactor may comprise one or more helical support surfaces which have a helical axis aligned with (e.g., coaxial) with the elongate axis of the vessel. In this embodiment, each helix may be considered a single support forming multiple barriers along the length of the elongate vessel. One or both sides of the support may form a support surface for the solid catalyst. In a helical embodiment, gas would be able to move between the adjacent barriers around the helical axis. Again, the openings being distributed along the length of the conduit would facilitate gas flow to be injected into or extracted from the helix at different positions along the helical axis.

In the embodiments described above, in the growth stage, reactants are introduced via the conduit centrally and move towards the periphery of the vessel. In other embodiments, the gas flow direction may be reversed, with gas flowing from the periphery of the vessel towards the centre where any remaining gas would be removed from the vessel through the central conduit.

Although the present invention has been described and illustrated with respect to preferred embodiments and preferred uses thereof, it is not to be so limited since modifications and changes can be made therein which are within the full, intended scope of the invention as understood by those skilled in the art.

1. A reaction assembly comprising:
an inlet;
an outlet;
an elongate vessel defining a reaction chamber in fluid communication with the inlet and the outlet;
one or more planar supports within the reaction chamber, the one or more planar supports having surfaces for supporting a solid catalyst, and being mounted transversely to, and forming a series of spaced-apart barriers along, an elongate axis of the vessel; and
a conduit positioned within the reaction chamber and connected to the inlet or the outlet, the conduit comprising conduit openings positioned between successive barriers, such that gas flow from the inlet to the outlet causes gas to flow through the conduit and through the reaction chamber along the support surfaces between successive barriers.

2-3. (canceled)

4. The reaction assembly according to claim 1, wherein the support surfaces are connected to and in thermal communication with the conduit, and wherein the support surfaces form a heat exchanger.

5. The reaction assembly according to claim 1, wherein there is a gap between each an outer edge of the spaced-apart barriers and an interior surface of the wall of the elongate vessel, the gaps allowing gas flow along the length of the elongate vessel.

6. The reaction assembly according to claim 1, wherein the vessel comprises a drainage exit for removing liquids.

7. (canceled)

8. The reaction assembly according to claim 1, wherein the solid catalyst is configured to catalyze a reaction which converts gaseous reactants into a solid product.

9. The reaction assembly according to claim 1, wherein the solid catalyst is configured to catalyze a reaction which converts gaseous hydrogen and carbon monoxide into carbon nanofibers and water.

10. The reaction assembly according to claim 1, wherein the catalyst is distributed on both sides of the barriers.

11. The reaction assembly according to claim 1, wherein, in operation, the barriers are aligned vertically.

12. The reaction assembly according to claim 1, wherein the solid catalyst comprises catalytic particles comprising one or more of: a group VIII metal, Fe, Ni, Cu, Zn, Co and Mo.

13. (canceled)

14. A method of producing carbon nanofibers using a reaction assembly including an inlet, an outlet, an elongate vessel defining a reaction chamber in fluid communication with the inlet and the outlet, one or more planar supports within the reaction chamber, the one or more planar supports having surfaces for supporting a solid catalyst, and being mounted transversely to, and forming a series of spaced-apart barriers along, an elongate axis of the vessel, and a conduit positioned within the reaction chamber and connected to the inlet or the outlet, the conduit comprising conduit openings positioned between successive barriers, such that gas flow from the inlet to the outlet causes gas to flow through the conduit and through the reaction chamber along the support surfaces between successive barriers, the method comprising:
injecting gaseous reactants into the reaction chamber through the inlet and removing gas from the outlet such that a flow of the gaseous reactants passes over the solid catalyst, the solid catalyst being configured to convert the gaseous reactants into products, wherein the products include carbon nanofibers.

15. The method according to claim 14, wherein the reactants comprise hydrogen and carbon monoxide.

16. The method according to claim 14, wherein the method comprises, prior to injecting the gaseous reactants, injecting a catalyst fluid containing catalytic particles into the assembly via the one or more inlets to populate the surfaces.

17. The method according to claim 16, wherein the catalytic particles comprise one or more of: a group VIII metal, Fe, Ni, Cu, Zn, Co and Mo; and
wherein the method comprises annealing and reducing the catalytic particles to form a lower oxidation state of each active site.

18. (canceled)

19. The method according to claim 17, wherein the method comprises, prior to injecting the catalyst fluid containing catalytic particles into the reaction chamber, forming a passive layer on the inner surface of outer vessel.

20-22. (canceled)

23. The method according to claim 14, wherein the method comprises:
harvesting the carbon nanofibers by flowing a harvesting fluid through the reaction chamber to dislodge the carbon nanofibers from the support surfaces, and
separating the carbon nanofibers from the harvesting fluid outside the reaction chamber.

24. The method according to claim 23, wherein the method comprises, prior to harvesting the carbon nanofibers, introducing an oxidizing agent into the reaction chamber, and increasing the temperature inside the reaction chamber.

25-26. (canceled)

27. The method according to claim 23, wherein the harvesting fluid is injected into the vessel via one or more directional nozzles, each directional nozzle being positioned adjacent to a said planar support, and being configured to inject the harvesting fluid in a direction along the planar support surface.

28. The method according to claim 14, the method comprising injecting catalyst particles into the reaction chamber in a seeding stage such that the catalyst particles are affixed to the support surfaces.

29. The method according to claim 14, the method comprising flowing a harvesting fluid through the chamber in a harvesting stage to remove the grown carbon nanofibers from the catalyst support surfaces and to extract the removed carbon nanofibers from the reaction chamber.

30. A method of producing carbon nanofibers using a reaction assembly including an inlet, an outlet, an elongate vessel defining a reaction chamber in fluid communication with the inlet and the outlet, one or more planar supports within the reaction chamber, the one or more planar supports having surfaces for supporting a solid catalyst, and being mounted transversely to, and forming a series of spaced-apart barriers along, an elongate axis of the vessel, and a conduit positioned within the reaction chamber and connected to the inlet or the outlet, the conduit comprising conduit openings positioned between successive barriers, such that gas flow from the inlet to the outlet causes gas to flow through the conduit and through the reaction chamber along the support surfaces between successive barriers, the method comprising cycling between the following stages:
a seeding stage comprising catalyst particulates are injected into the reaction chamber, affixed to the support surfaces and then activated;
a growth stage in which gaseous reactants are flowed through the reaction chamber over the catalyst support surfaces to be converted into the carbon nanofibers; and
a harvesting stage in which a harvesting fluid is flowed through the reaction chamber to remove the grown carbon nanofibers from the catalyst support surfaces and to extract the removed carbon nanofibers from the reaction chamber.
